(19) United States
(12) Patent Application Publication
(10) Pub. No.: US 2026/0001498 A1
(43) Pub. Date: Jan. 1, 2026

(54) Power Rail Assembly for Vehicle

(71) Applicant: Karma Automotive LLC, Irvine, CA (US)

(72) Inventors: James Leroy Jones, III, Irvine, CA (US); Atul Deshpande, Irvine, CA (US)

(73) Assignee: Karma Automotive LLC, Irvine, CA (US)

(21) Appl. No.: 18/754,428

(22) Filed: Jun. 26, 2024

(51) Int. Cl. B60R 16/02; B60R 16/023; H01B 7/00

(52) U.S. Cl. CPC B60R 16/0215; B60R 16/0238; H01B 7/0045

(57) ABSTRACT

A power rail assembly for a vehicle includes a tray configured for mounting the power rail assembly at a vehicle. A power connector is accommodated by the tray and is configured to electrically connect between a power source of the vehicle and an electrically operable component of the vehicle with the power rail assembly mounted at the vehicle. A data connector is accommodated by the tray and is configured to communicatively connect between a master control module of the vehicle and a zonal control module of the vehicle with the power rail assembly mounted at the vehicle.

### TECHNICAL FIELD

This disclosure relates to power rail assemblies for vehicles, and more particularly, power rail assemblies for vehicles having modular platforms.

### BACKGROUND

It is known to provide a vehicle structural frame that supports a vehicle suspension, a drivetrain, one or more vehicle batteries for electrically powering the drivetrain, and a vehicle body providing a cabin to accommodate the occupants of the vehicle. However, vehicles in different segments (e.g., coupes, sedans, SUVs, and the like) typically require distinct frames that are designed and manufactured with diverse components and constructions configured for the particular product line. This leads to expensive and time-consuming product development and manufacturing processes that can result in high waste and increased business risk.

Moreover, the unique configurations across different vehicles generally causes each vehicle to have a distinctive and complicated wiring harness to electrically connect the power systems and electronic components of the vehicle. Conventional wiring harnesses typically require extensive lengths of cable to distribute power and data, leading to high labor and manufacturing costs while the high number of interconnections promote failure due to splices, circuits, and crimps. Wiring poses a frequent challenge for vehicle design, packaging, and assembly as changes can lead to significant downstream effects.

### SUMMARY

One aspect of the disclosure provides a power rail assembly for a vehicle. The power rail assembly includes a tray configured for mounting the power rail assembly at the vehicle. A power connector is accommodated by the tray. The power connector is configured to electrically connect between a power source of the vehicle and an electrically operable component of the vehicle with the power rail assembly mounted at the vehicle. A data connector is accommodated by the tray. The data connector is configured to communicatively connect between a master control module and a zonal control module of the vehicle with the power rail assembly mounted at the vehicle.

Implementations of the disclosure may include one or more of the following optional features. In some implementations, the tray mounts along a chassis of the vehicle. In further implementations, the electrically operable component is disposed at a body of the vehicle mated to the chassis of the vehicle.

In some example, the tray extends along a centerline of the vehicle. In other examples, the tray extends along a respective side of the vehicle.

In some aspects, a fuse box is electrically connected between the power connector and the electrically operable component. The fuse box is mounted to the tray. In further aspects, the fuse box is electrically connected between the power source and the power connector. In some implementations, the zonal controller is electrically connected between the power connector and the electrically operable component.

In some examples, the power source includes a battery of the vehicle. The battery is configured to at least one of electrically power accessories of the vehicle, electrically power a propulsion system of the vehicle, or electrically connect to the power connector via a DC-DC converter. In some aspects, the power connector and the data connector are stacked vertically relative to one another along the tray.

Another aspect of the disclosure provides a vehicle. The vehicle includes a power source, an electrically operable component, a master control module, a zonal control module, and a power rail assembly. The power rail assembly includes a tray mounting the power rail assembly at the vehicle. A power connector is accommodated by the tray. The power connector is electrically connected between the power source and the electrically operable component. A data connector is accommodated by the tray. The data connector is communicatively connected between the master control module and the zonal control module.

Implementations of the disclosure may include one or more of the following optional features. In some implementations, the tray mounts along a chassis of the vehicle. In further implementations, the electrically operable component is disposed at a body of the vehicle mated to the chassis of the vehicle.

In some example, the tray extends along a centerline of the vehicle. In other examples, the tray extends along a respective side of the vehicle.

In some aspects, a fuse box is electrically connected between the power connector and the electrically operable component. The fuse box is mounted to the tray. In further aspects, the fuse box is electrically connected between the power source and the power connector. In some implementations, the zonal controller is electrically connected between the power connector and the electrically operable component.

In some examples, the power source includes a battery of the vehicle. The battery is configured to at least one of electrically power accessories of the vehicle, electrically power a propulsion system of the vehicle, or electrically connect to the power connector via a DC-DC converter. In some aspects, the power connector and the data connector are stacked vertically relative to one another along the tray.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective view of a vehicle having a zonal control architecture and a power rail assembly.

FIG. 2A is a perspective view of a traditional wiring harness.

FIG. 2B is a perspective view of the zonal architecture and the power rail assembly of the vehicle of FIG. 1, with localized wiring harnesses connecting components to zonal controllers.

FIG. 3 is a perspective view of a chassis of the vehicle, with the zonal architecture and power rail assembly mounted to the chassis.

FIG. 4 is a perspective view of a body portion and the chassis of the vehicle mated together.

FIG. 5 is another perspective view of the chassis of the vehicle.

FIG. 6 is a perspective view of the chassis of the vehicle, with the power connector of the power rail assembly disposed at the chassis.

FIG. 7 is a perspective view of the chassis of the vehicle, with the data connector of the power rail assembly disposed at the chassis.

FIG. 8 is a perspective view of the power rail assembly of the vehicle.

FIG. 9 is a perspective view of the power rail assembly of the vehicle connected to the zonal architecture.

FIG. 10 is an enlarged perspective view of a zonal controller of the zonal architecture electrically and communicatively connected to the power rail assembly.

FIG. 11 is an enlarged perspective view of a master controller of the zonal architecture communicatively connected to the power rail assembly.

FIG. 12 is a perspective view of the power connector and fuse boxes mounted to the tray of the power rail assembly.

FIG. 13 is a perspective view of the power connector and fuse boxes removed from the tray of the power rail assembly.

FIG. 14 is an enlarged perspective view of a fuse box mounted to the power connector of the power rail assembly.

FIG. 15 is an exploded view of the fuse box.

FIG. 16 is an enlarged perspective view of the power connector and data connector accommodated at the tray of the power rail assembly.

FIG. 17 is an enlarged perspective view of an auxiliary battery of the vehicle electrically connected to the power rail assembly. Like reference symbols in the various drawings indicate like elements.

### DETAILED DESCRIPTION

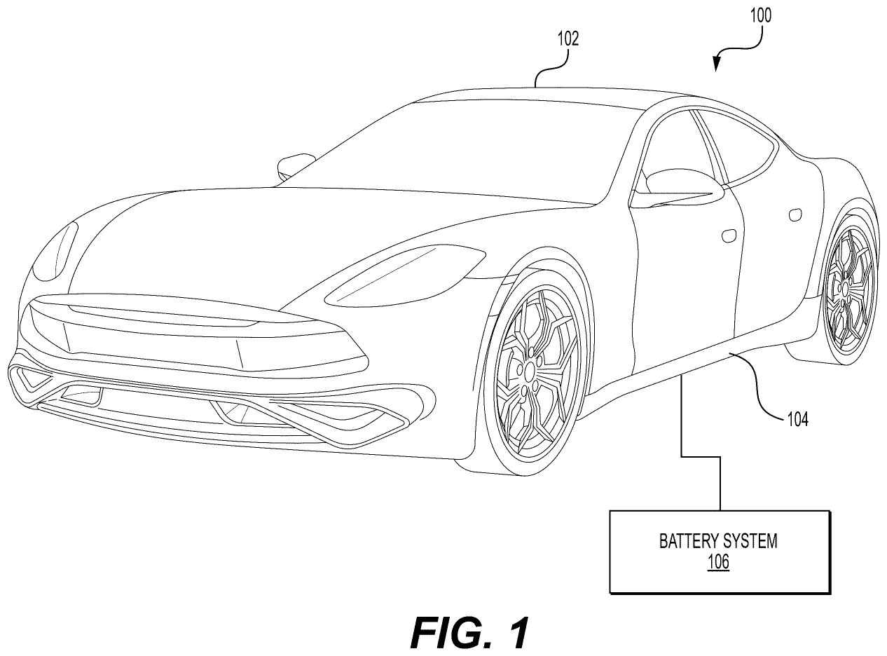

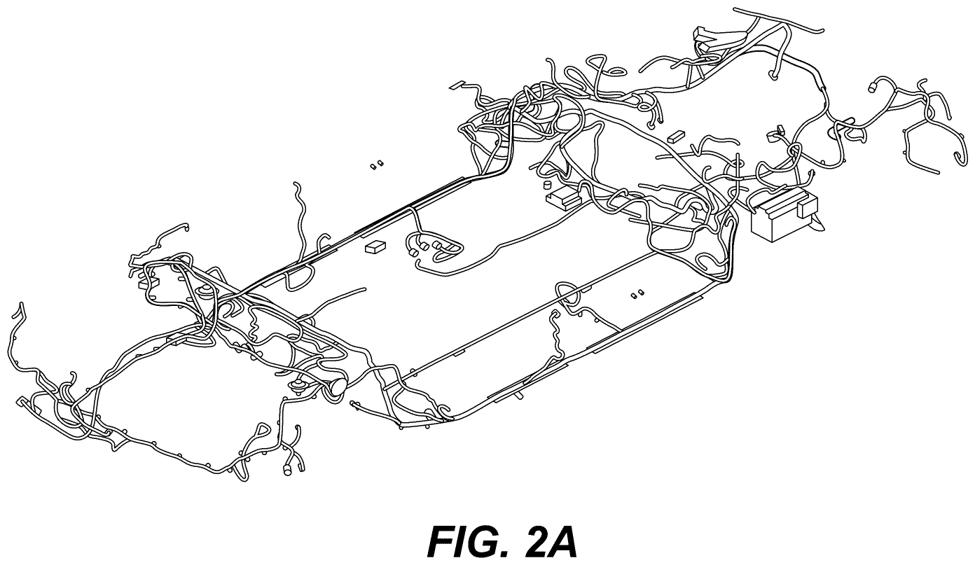

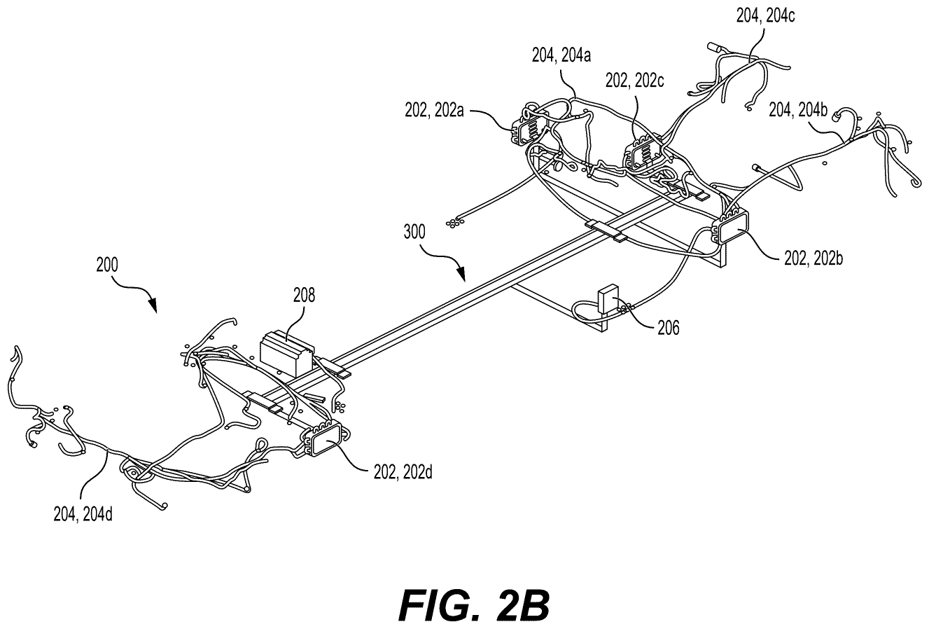

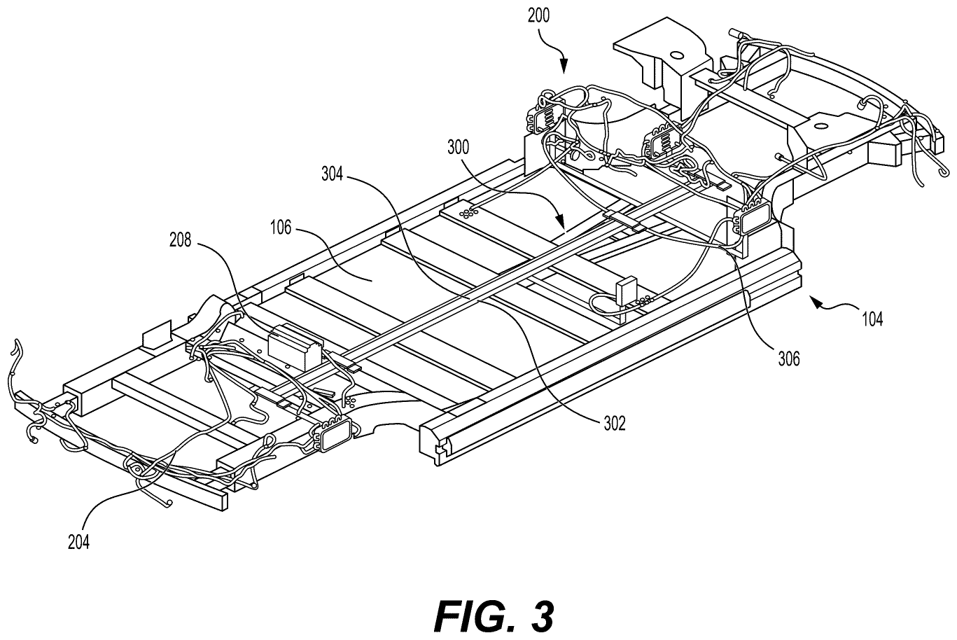

Referring to FIG. 1, a vehicle 100, such as a battery-powered electric vehicle or plug-in hybrid vehicle, includes a vehicle body or top-hat portion 102 mated to a vehicle chassis or frame portion 104. The chassis 104 accommodates, among other vehicle components and systems, a battery pack or high voltage (HV) battery system 106 for at least partially electrically powering a propulsion system of the vehicle 100. The vehicle body 102 provides an interior cabin for occupants of the vehicle and accommodates one or more electronic components or systems of the vehicle 100, including light modules (e.g., headlamps, taillamps, turn signal indicators, fog lights, and the like), an HVAC system, vehicle sensors (e.g., cameras, radar sensors, lidar sensors, and the like). The chassis 104 may provide a modular platform or “skateboard” configured to receive different vehicle bodies to produce various vehicle platforms, and the vehicle 100 may incorporate a zonal architecture or zonal control system 200 (FIG. 2B) for control of the various electronic components and systems of the vehicle 100. Further, the vehicle 100 is equipped with a power rail assembly 300 (FIG. 3) mounted to the chassis 104 and configured to provide a modular solution for power and data distribution across the vehicle 100 to reduce vehicle wire harness complexity and improve modularity of the vehicle platform.

In contrast to a domain architecture in which vehicle systems are grouped by function, a vehicle implementing a zonal architecture offers a more efficient solution by grouping functions within a vehicle into several zones. Here, each zone in a zonal architecture includes a respective set of devices that are installed in a particular section of the vehicle and are connected to a respective locally installed zonal controller or gateway. The respective set of devices associated with each zone of the zonal architecture and in communication with the respective zonal controller may include sensors and/or actuators such as, without limitation, light devices, air conditioning, suspension, electronics, parking assistance, batteries, inverters/motors, an engine, power steering components, power braking components, and radios including ultra-wideband radios.

Because the zonal controller is close to the devices it controls and/or communicates with, the communication paths (e.g., cables or wireless communications) are relatively short. In the zonal architecture, each zonal controller is connected to a central controller/computer that may have supervisory control over all of the zones and may be responsible for facilitating communications between the vehicle and devices/entities remote from the vehicle. As a result, the communication between zonal controllers and the central controller resembles that of a computer network rather than an automotive harness, thereby enabling the inter-zonal communication to occur over a small, high-speed networking cable that greatly reduces the quantity and size of the cables that must be installed around the vehicle. In some configurations, at least a portion of the inter-zonal communications between the zonal controllers and the central controller occur over a wireless network. Notably, a combination of wireless and wired/cabled communications are utilized for the central controller and the zonal controllers to communicate with one another.

For example, and such as shown in FIG. 2B, the zonal control system 200 of the vehicle 100 implements a plurality of zonal controllers 202, 202a-n for grouping functions within the vehicle 100 into specific zones. Namely, each zonal controller 202 is assigned to a respective zone of the vehicle 100 and is connected to a respective set of components that are installed in or near the respective zone the zonal controller 202 is assigned. In the example shown, each zonal controller 202 is locally installed in the respective zone of the vehicle 100 in which the respective set of components are installed. For instance, a first zonal controller 202a is installed on a front driver-side zone, a second zonal controller 202b is installed in a front passenger-side zone, a third zonal controller 202c is installed in a front storage or engine compartment or frunk zone, and a fourth zonal controller 202d is installed in a rear storage or trunk zone. Other configurations are possible as well. For instance, a respective zonal controller 202 may be assigned to each one of a front zone including respective components installed on the front of the vehicle 100, a first side zone including a respective set of components installed on a right side or left side of the vehicle 100, a second side zone including a respective set of components installed on the other one of the right side or the left side of the vehicle 100, and a rear zone including a respective set of components installed on a rear of the vehicle 100. The number of zonal controllers 202 is non-limiting such that the vehicle 100 may equally include less than four zonal controllers 202 or more than four zonal controllers 202 without departing from the scope of the present disclosure.

The respective set of components associated with each zone of the zonal architecture and in communication with the respective zonal controller 202 may include sensors and/or actuators. For instance, the respective set of components may include, without limitation, sensors, lights, actuators, heating ventilation and air conditioning (HVAC) systems, steering systems, brakes, parking brakes, safety devices (airbag controls devices, vehicle dynamic control (VDC) devices, electronic stability control (ESC) devices, etc.), suspension devices, power windows, power trunks/lift gates, electronics, parking assistance systems, batteries, inverters/motors, an engine, cameras, and communication interfaces.

Localized wiring harnesses 204, 204a-n distribute power and data between the components and the respective zonal controllers 202. Since each zonal controller 202 is close to the components it controls and/or communicates with, the communication paths (e.g., cables or wireless communications) are relatively short. For example, compare the localized wiring harnesses 204 extending between vehicular components and zonal controllers 202 within designated zones as shown in FIG. 2B with the extensive wiring present in a vehicle not equipped with zonal architecture as shown in FIG. 2A.

In the illustrated example, the vehicle 100 includes a first localized wiring harness 204a connecting between the first zonal controller 202a and respective components assigned to the front driver-side zone, a second localized wiring harness 204b connecting between the second zonal controller 202b and respective components assigned to the front passenger-side zone, a third localized wiring harness 204c connecting between the third zonal controller 202c and respective components assigned to the front storage or engine compartment zone, and fourth localized wiring harness 204d connecting between the fourth zonal controller 202d and respective components assigned to the rear storage or trunk zone. Other configurations are possible as well, such as based on the positions and assigned zones of the zonal controllers 202 and vehicle components.

In the zonal architecture, each zonal controller 202 is in communication with the other zonal controllers 202 and a master controller 206 that acts as a central controller having supervisory control over all the zones and may be responsible for facilitating communications between the vehicle and devices/entities remote from the vehicle. The zonal controllers 202 and the master controller 206 may communicate with one another via a CAN bus, LIN bus, Ethernet, and/or other communication paths. Wireless communication paths are also possible. Each zonal controller 202 may communicate with the respective set of components via any wired or wireless communication protocol such, as without limitation, CAN, LIN, Ethernet, Wireless Fidelity (WiFi), or any short range wireless communication standard.

Moreover, the zonal controllers 202 may distribute power to the connected electrical components, such as from the HV battery system 106 of the vehicle 100 (e.g., by way of a DC/DC converter) and/or from an auxiliary battery 208 (e.g., a 12V battery) of the vehicle 100. As discussed further below, power and data may be distributed between the zonal controllers 202 and/or other vehicle components and throughout the vehicle 100 via a power rail assembly 300 that extends the length of the vehicle 100.

Thus, the extensive body harness (e.g., FIG. 2A) is eliminated or greatly reduced by moving circuitry and power distribution onto the power rail assembly 300 between the power sources of the vehicle and the zonal architecture, with localized wiring harnesses 204 between the zonal controllers 202 and vehicle components providing consolidated or targeted power and data distribution. This may also eliminate or reduce inline wire connectors and grommet pass-throughs in the vehicle body 102, such as at the dash panel.

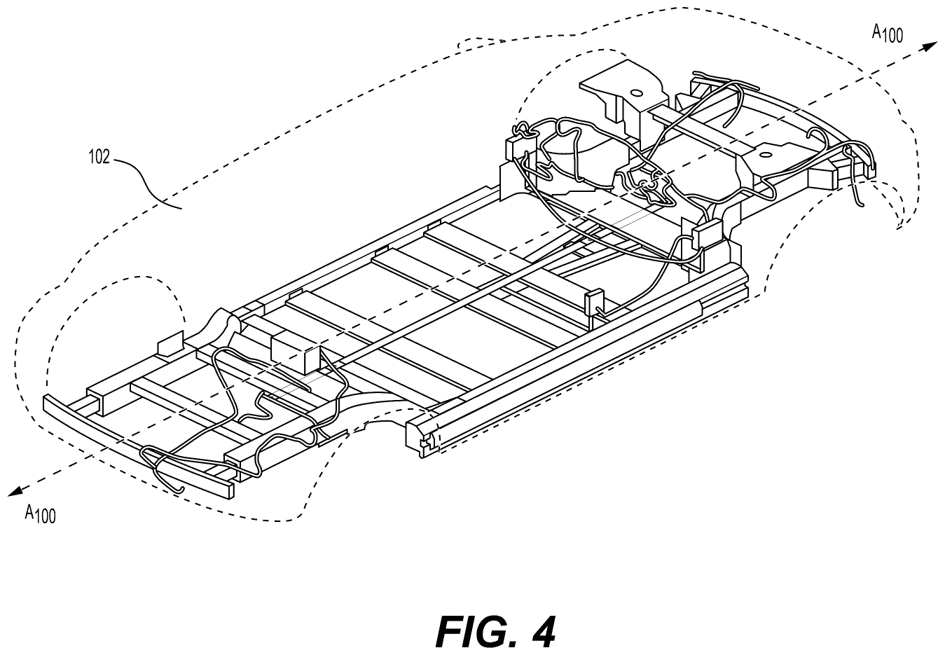

Referring to FIGS. 3 and 4, the HV battery system 106, the zonal control system 200 (including the zonal controllers 202, localized wiring harnesses 204, and master controller 206), the auxiliary battery 208, and the power rail assembly 300 are accommodated at the chassis or skateboard portion 104 of the vehicle 100, and the electronic components may be accommodated at the top-hat or body portion 102 of the vehicle 100. This allows for simple connections between the localized wiring harnesses 204 and electronic components when the body 102 is mated to the chassis 104 to begin delivering power and data via the power rail assembly 300 and zonal control system 200.

To further simplify the assembly process of the vehicle 100, the power rail assembly 300 may provide a pre-assembled component that is installed onto the electrified chassis or skateboard 104. In the illustrated example, the power rail assembly 300 includes a rigid, insulated tray 302 that acts as a carrier that accommodates a power connector 304 and data connector 306 that extend along the tray 302. The power connector 304 is configured to electrically connect between a power source of the vehicle 100 (e.g., the HV battery system 106 and/or the auxiliary battery 208) and one or more electronic components of the vehicle 100 for delivering power to the vehicle components. For example, the power connector 304 may deliver power to the zonal controllers 202 for distribution to the vehicle components. The data connector 306 is configured to communicatively connect between the master controller 206 of the vehicle 100 and one or more zonal controllers 202 for transmitting data within the zonal architecture.

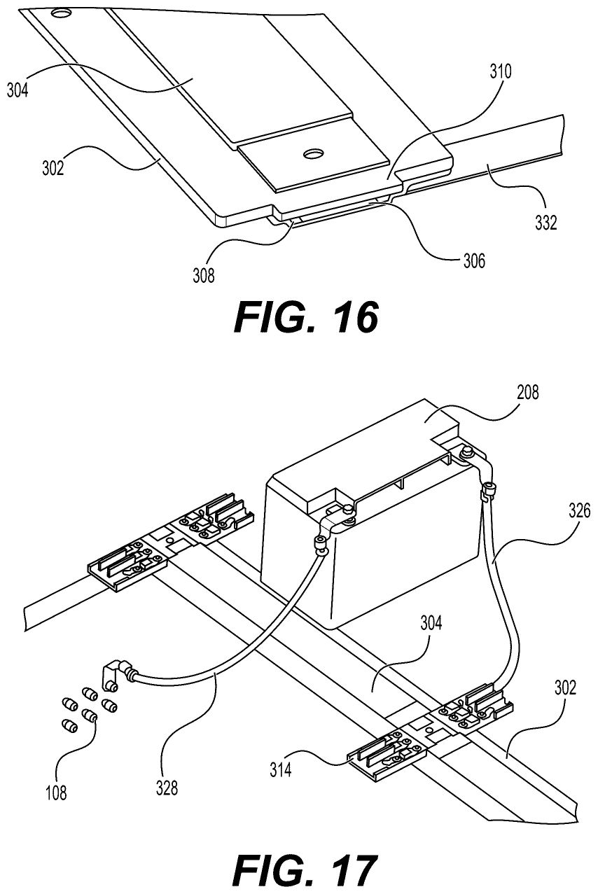

The tray 302, the power connector 304 and at least a portion of the data connector 306 may be vertically stacked relative to one another, such as to provide compact packaging. For example, the tray 302 may provide a tray-within-a-tray carrier design, where the data connector 306 is disposed along a lower channel or portion 308 of the tray 302 and the power connector 304 is disposed along an upper channel or portion 310 of the tray 302 that extends above the lower channel 308 (FIG. 16). The upper channel 310 and the lower channel 308 may be separated by a surface or divider of the tray 302, or the upper channel 310 may include outer flanges or wings for supporting the power connector 304 above the data connector 306. In other examples, the power connector 304 may be directly stacked on top of the data connector 306.

As shown in FIG. 4, the tray 302 is configured for mounting the power rail assembly 300 at the vehicle 100, such as along the chassis 104 above the HV battery system 106 and below a floor of the body 102. That is, the power rail assembly 300 may be directly attached to the floor of the chassis 104, such as via M6 bolts or other suitable fasteners. Vibration may be minimized by attaching the tray 302 between the chassis 104 and vehicle body 102. Moreover, since the power rail assembly 300 resides in an intrinsically dry area of the vehicle 100 (e.g., below the floor of the vehicle cabin), no sealed connections are necessary (e.g., between the power source and power connector 304, or between the power connector 304 and zonal controllers 202). However, sealed connections may be used, such as to ensure robust connectivity to the power connector 304.

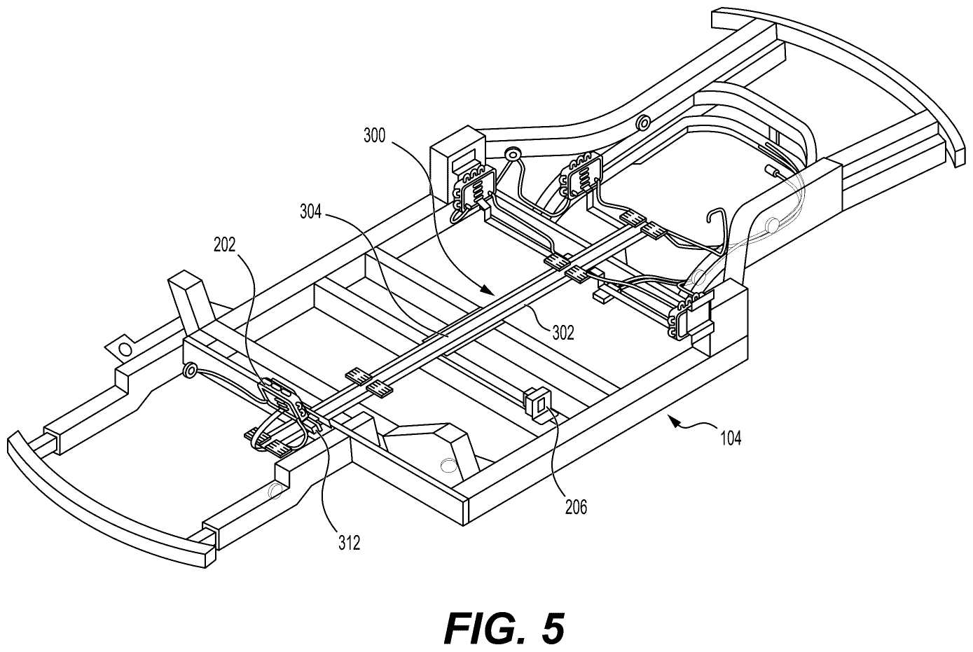

Because sealed connections may not be necessary, the tray 302 and power rail assembly 300 may extend substantially the length of the chassis 104 and at least partially into under-hood and/or trunk regions of the vehicle body 102. To protect the unsealed connections and/or other vehicle components, sealing components such as rubber grommets 312 are disposed along the tray 302 where the power rail assembly 300 passes through a wall of the body 102 and/or portion of the chassis 104 (e.g., through a cross-brace) and into the under-hood or trunk regions (FIG. 5).

In the illustrated example, the tray 302 and power rail assembly 300 extend generally along a centerline or center portion of the chassis 104 and parallel to a longitudinal axis A₁₀₀ of the vehicle 100 (FIG. 4). Optionally, the tray 302 and power rail assembly 300 may be offset from the centerline of the vehicle 100, such as extending along a respective side of the vehicle 100. In some aspects, the power rail assembly 300 includes multiple, separate trays 302 accommodating respective power connectors 304 and/or data connectors 306, such as one tray 302 extending along an interior sill or rocker rail at a first side of the vehicle 100 and another tray 302 extending along an interior sill or rocker rail at an opposite second side of the vehicle 100. Moreover, the power rail assembly 300 and tray 302 (and thus the power connector 304 and data connector 306 accommodated by the tray 302) may be arranged in any suitable shape or configuration, such as a U-shaped power rail assembly, an L-shaped power rail assembly, and the like.

The power connector 304 may include a solid and rigid bus bar having a length suitable for the vehicle application and that is insulated and stamped for simplicity. The power connector 304 may be sized based on the required current carrying capability, such that the bus bar is configured for 200 amps or 300 amps of continuous load, with a maximum inrush of 800 amps or more. In some examples, the power connector 304 includes multiple bus bars, such as side by side or stacked relative to one another in the tray 302. The power connector 304 delivers power from the HV battery system 106 and/or the auxiliary battery 208 throughout the vehicle 100, such as via electrical connection through the zonal controllers 202 and/or via direct electrical connection between the vehicle component and the power connector 304. For example, vehicle components having an electric load greater than a threshold (e.g., 30 amps or more) may have independent electrical connections to the power connector 304 whereas vehicle components having electric loads less than the threshold may be electrically connected to the power connector 304 via the zonal controllers 202. This significantly reduces the wiring needs of the vehicle 100 as the localized wiring harnesses 204 need only extend between components and the zonal controller 202 within assigned zones.

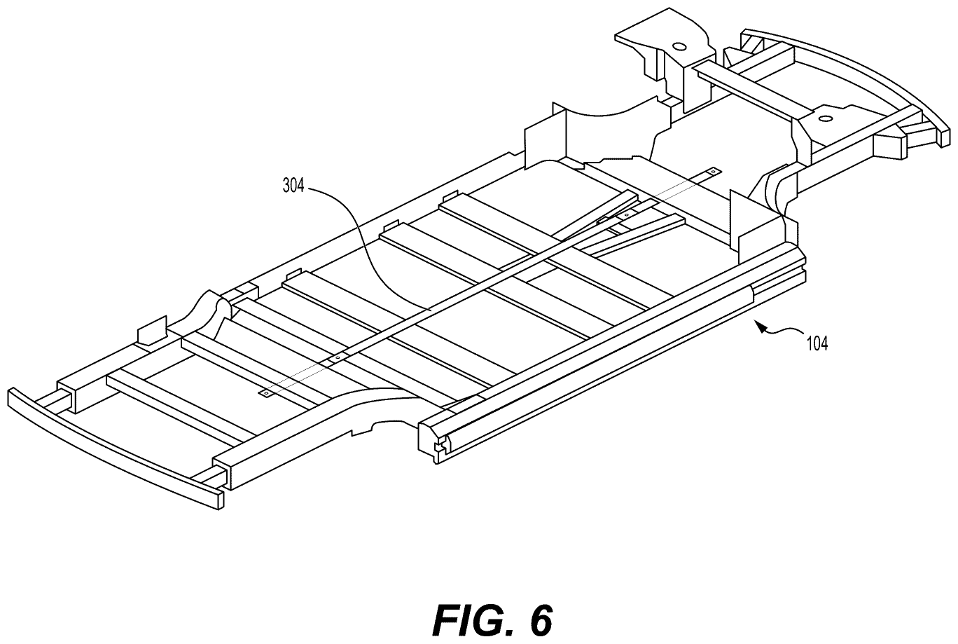

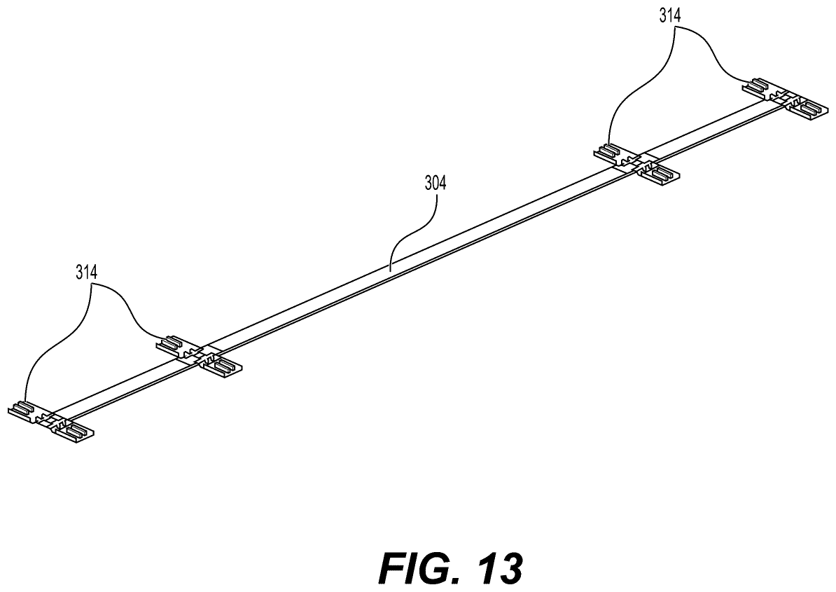

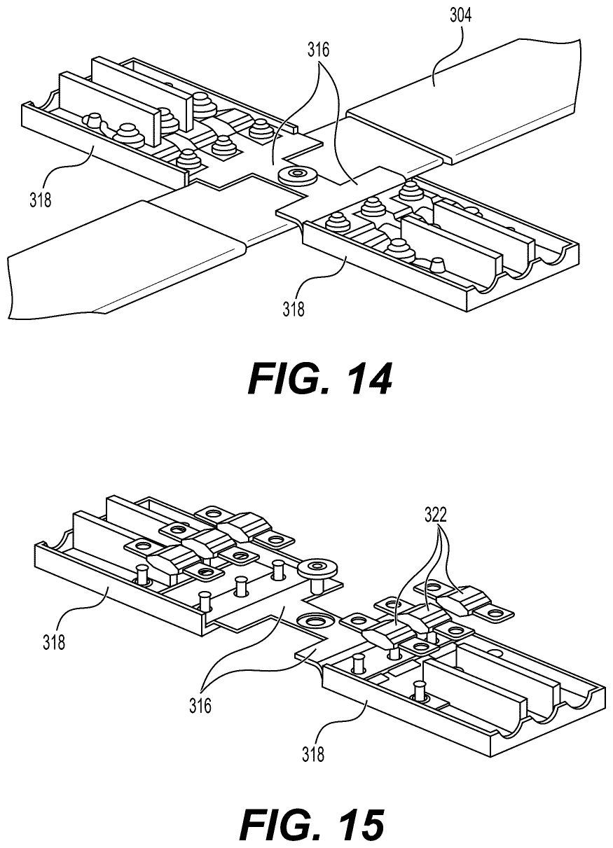

As shown in FIGS. 6 and 10-17, one or more fuse terminal boxes 314 may be disposed along the power rail system 300 for electrically connecting the power connector 304 to respective vehicle components (e.g., having electric loads greater than 30 amps), zonal controllers 202, and/or the power sources of the vehicle 100. The fuse boxes 314 are directly attached to the power connector 304, with tab regions 316 bolted (or otherwise directly fastened) to the power connector 304 and connected to box portions 318 extending laterally from the tab regions 316 on opposing sides of the power connector 304. For example, threaded fasteners 320, such as M8 bolts or other suitable fasteners, attach the tab regions 316 to the power connector 304 to electrically connect the fuse box 314 to the power connector 304. The fasteners 320 may optionally attach the power connector 304 to the tray 302.

Fuses 322 are electrically connected at each terminal portion 318 for establishing electrical connection between the fuse box 314 and a power source, vehicle component, and/or the zonal architecture. In the illustrated example, each box portion 318 accommodates three fuses 322 for a three by three fuse box 314 with six high current fuses (e.g., between 35 amps and 200 amps), but any suitable number and/or size of fuses 322 and electrical connections may be accommodated by each fuse box 314. The fuses 322 may be swapped or replaced based on electrical requirements of the power rail system 300. The fuse boxes 314 are low profile to facilitate the sub-floor packaging of the power rail assembly 300.

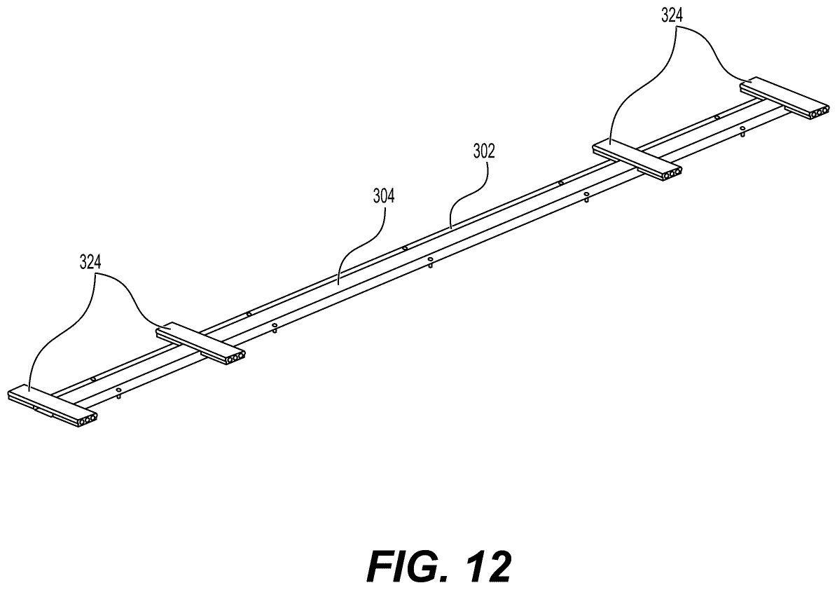

As shown in FIG. 12, each fuse box 314 is equipped with a respective insulating and sealing cover 324 to provide environmental protection, such as from dirt and water. The covers 324 may be removable, such as for replacing fuses 322 during maintenance. Moreover, the covers 324 may provide smooth outer surfaces, such as to ensure water management drainage.

The number and positioning of the fuse boxes 314 along the power connector 304 may be selected strategically based on needed electrical connections. Based on an optimal connection point, the power connector 304 is electrically connected to the HV battery system 106 (e.g., via the DC/DC converter) and/or the auxiliary battery 208 via one of the fuse boxes 314. For example, and as shown in FIG. 17, the auxiliary battery 208 may be electrically connected to the power connector 304 via a positive ring terminal cable 326 connected between the auxiliary battery 208 and a fuse box 314 at the power connector 304. A negative ring terminal cable 328 may be connected between the auxiliary battery 208 and a ground of the vehicle 100, such as bolted to a welded nut array 108 at the chassis 104 of the vehicle 100. This may simplify battery cabling as the auxiliary battery 208 may be packed onto or with the chassis 104. The DC/DC converter of the HV battery system 106 and the auxiliary battery 208 may be connected together to ensure charging of the auxiliary battery 208.

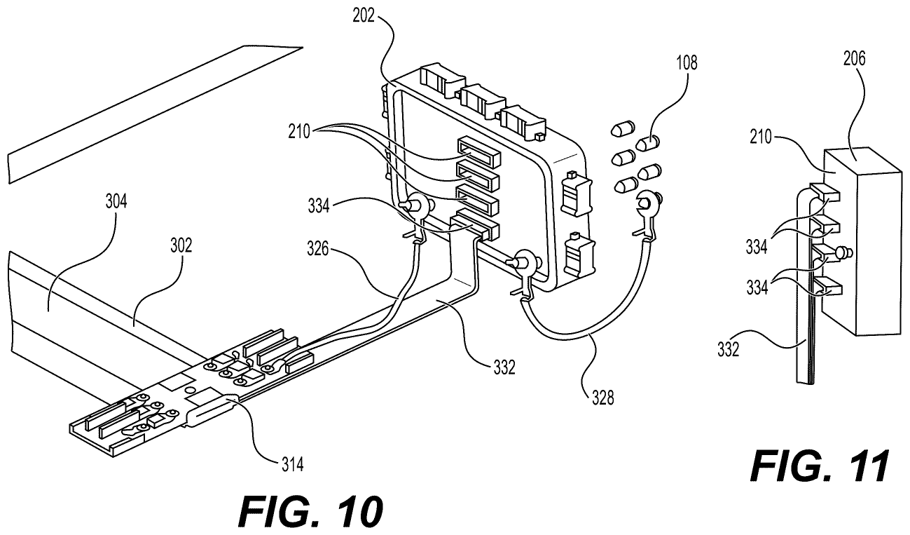

Referring to FIG. 10, positive ring terminal cables 326 also electrically connect between the fuse boxes 314 and the zonal controllers 202 while negative ring terminal cables 328 ground the zonal controllers to welded nut arrays 108 of the vehicle 100. Thus, the zonal architecture may be powered directly from the power connector 304 and grounded locally to the nut array 108. The zonal controllers 202 may then provide fused power to the vehicle components, such as for electrical loads between about 1 amp to 30 amps. For example, the zonal controllers 202 may provide switched power outputs via relay for electrical loads greater than 10 amps, field-effect transistors (FET) for electrical loads between 1 amp and 9 amps, and bipolar junction transfer (BJT) for electrical loads less than 1 amp. Because the zonal controllers 202 provide the wiring harness interconnects and circuit splicing, no splicing or inline connections along the localized wiring harnesses 204 may be needed.

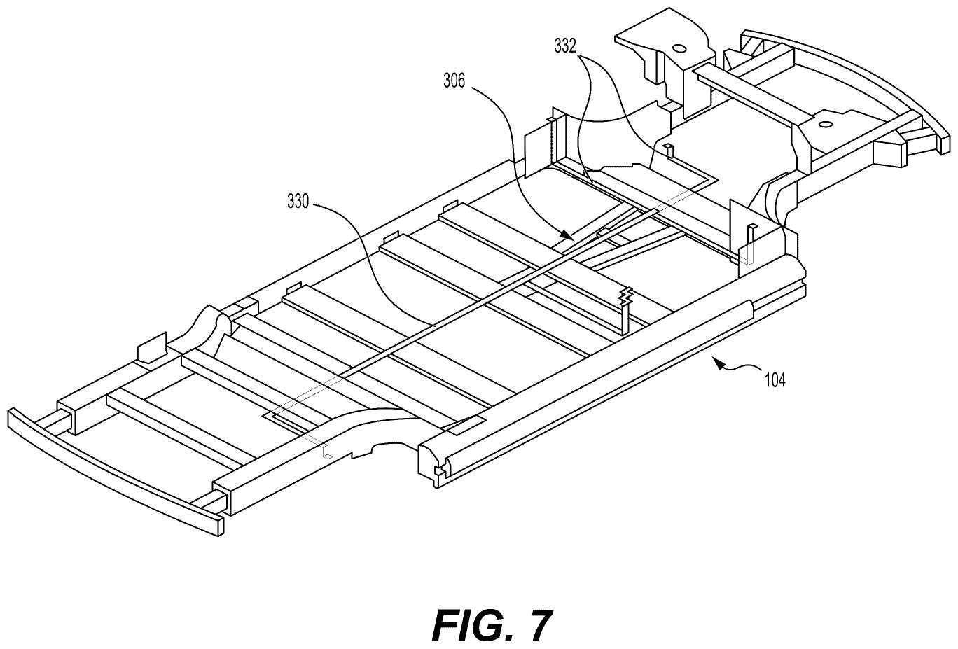

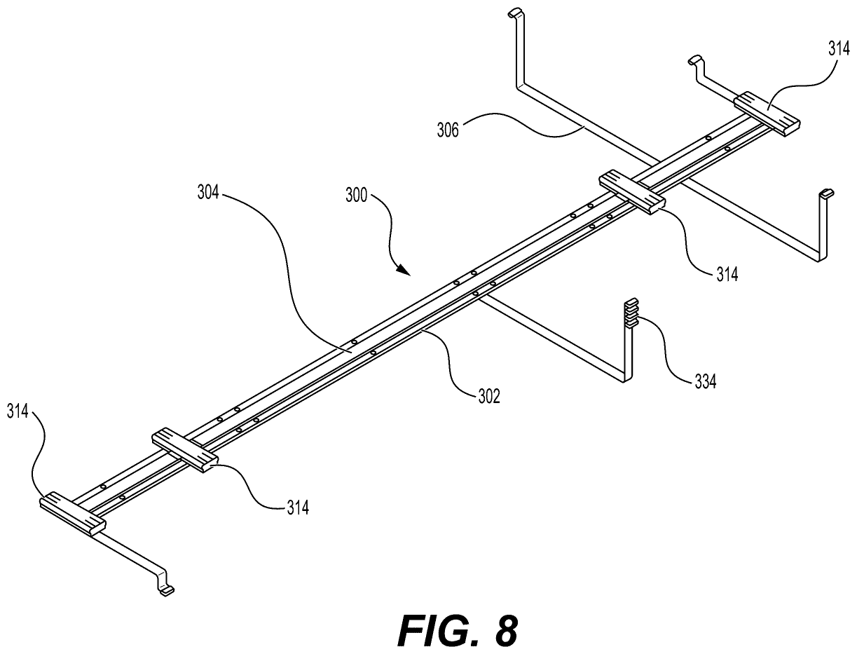

Referring to FIGS. 7-11, a primary portion or spine portion 330 of the data connector 306 is accommodated along the tray 302 with connecting portions or takeouts 332 of the data connector 306 extending from the primary portion 330 and tray 302 for connecting to the respective master control module 206 and zonal controllers 202. In some examples, the tray 302 includes branches or extensions for accommodating the connecting portions 332. The data connector 306 may be formed from one or more flexible printed circuits (FPCs) that are stacked within the tray 302, with the primary portion 330 disposed below (or optionally above) the power connector 304. The connecting portions 332 extend from the primary portion 330 at right angles for ease of the FPC assembly, where ultra sonic welding of the FPC may be used to create splices. When multiple FPCs are used to form the data connector 306, adhesive backed laminate may adhere the FPCs on top of one another.

Each connecting portion 332 includes one or more connectors or plugs 334 for communicatively coupling to the zonal architecture. For example, each zonal controller 202 and the master controller 206 may include ports 210 (such as four or more ports 210) configured to receive respective connectors 334 of the data connector 306 (FIGS. 10 and 11). Each connector 334 may correspond to a respective FPC of the data connector 306, or a respective spliced portion of the FPCs of the data connector 306. The connectors 334 may include any suitable hardware, such as 26-position FPC connectors that support up to 2 amps or more.

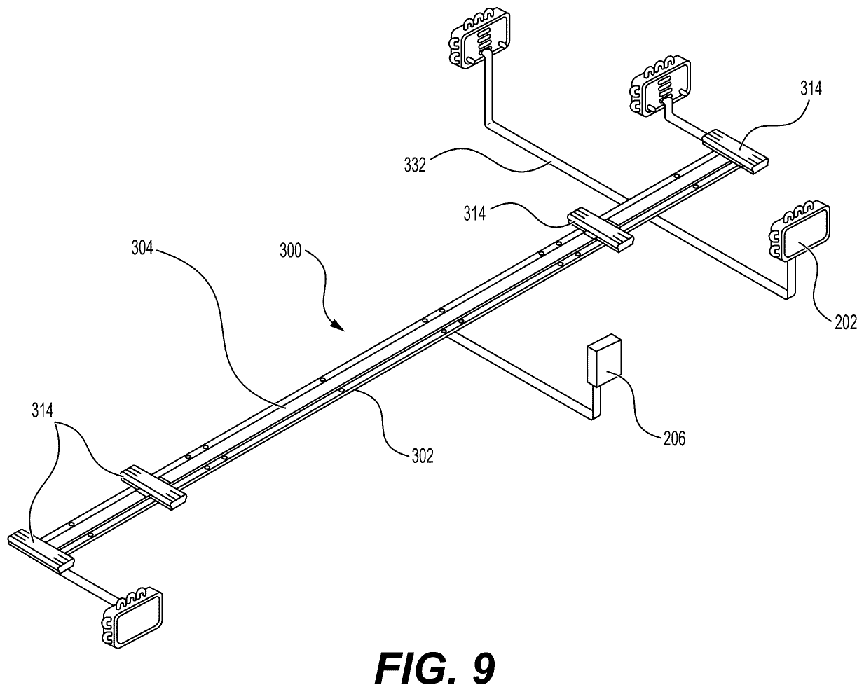

As shown in FIGS. 9-11, the master control module 206 and the zonal controllers 202 may be oriented at right angles to aid in connecting to the data connector 306. That is, because the connecting portions 332 extend at right angles to the primary portion 330, the zonal architecture is configured to allow for straight or linear paths between the ports 210 and the connecting portions 332. Put another way, an interface of the zonal architecture is normal to the connecting portion 332 extending from the primary portion 330 of the data connector 306. Moreover, the ports 210 of the master control module 206 and the zonal controllers 202 may be vertically stacked to accommodate the vertically stacked FPCs of the data connector 306.

The number and positioning of the connecting portions 332 extending from the primary portion 330 of the data connector 306 may be selected strategically based on needed connections. For example, connecting portions 332 may extend respectively between the primary portion 330 and each of the master control module 206, the first zonal controller 202a, the second zonal controller 202b, the third zonal controller 202c, and the fourth zonal controller 202d to communicatively couple the master control module 206 to the components assigned to each zone of the vehicle 100. Thus, the primary domain networks for the zonal architecture are accommodated by the data connector 306 with the fixed physical layer bus structure on the FPC providing minimal electromagnetic interference or radio frequency interference between the stacked FPCs of the data connector 306.

When the master control module 206 is communicatively connected to the zonal controllers 202, the zonal controllers 202 provide localized simple body control functions and may be master to LIN devices, based on control signals transmitted from the master control module 206. The zonal controllers 202 provide a physical gateway between the localized wiring harnesses 204 and the physical networks accommodated on the FPCs of the data connector 306 to the master control module 206. The zonal control modules 202 may communicate along the data connector 306 to the master control module 206 via CAN or other suitable bus network.

Prior to connection between the data connector 306 and the zonal architecture, the connecting portions 332 may be folded back and releasably retained at the primary portion 330 or the tray 302. This reduces the footprint of the power rail assembly 300 during installation and avoids interference with other components at the chassis 104. After mounting to the chassis 104, the connecting portions 332 may be detached from the primary portion 330 or the tray 302 to connect the connectors 334 at the respective ports 210 of the zonal architecture to provide communication between the master control module 206 and the zonal controllers 202. Further, the fuse boxes 314 may be electrically connected to the zonal architecture for delivering electrical power from the power sources of the vehicle 100 to the components at the vehicle body 102.

Thus, the zonal architecture provides power and data gateways to other components and modules on the chassis 104 and the body 102, with localized grounding arrays 108 disposed on the chassis 104 to provide electrical grounding. Power and data are distributed along the vehicle 100 in a compact and space-efficient manner via the power rail assembly 300. Localized wiring harnesses 204 and cabling are constrained to zones of the vehicle 100 for power, network connectivity, and grounding, thus reducing the number and sizes of the overall vehicle wiring harness. This may reduce voltage and ground offsets and provide greater energy efficiency due to the minimal cable lengths and use of a solid copper power connector 304. Accordingly, the system is configured to eliminate harness splices and inline connections as all splices can be moved into zonal control modules 202 that are strategically placed at the vehicle 100. Further, the system is grounded via pre-placed grounding arrays 108 rather than, for example, tacked on studs.

Moreover, vehicle assembly time may be greatly reduced by the reduction or elimination of grommet passthroughs, such as at the dash panel and package tray areas, the reduction or elimination of inline connections, and the reduction or elimination of body harness related circuits. Rather, the smaller localized harnesses 204 are constrained to the zones of the vehicle 100 and flexible harness circuits are converted onto the data connector 306 of the power rail assembly 300. Costs may be reduced based on the reduced assembly time, the reduced use of materials (e.g., copper for circuits due to optimal routing and thermal efficiency that reduces length and gauge of wiring), and the reduced use of connectors. Moreover, reliability and simplicity of the connections may be improved, providing reduced repair needs, quicker diagnosis, and reduced time to perform repairs. Vehicle weight may be reduced by the lighter weight FPCs and more efficient power distribution.

Further, the power rail assembly 300 with zonal architecture provides pre-defined electrical hardpoints and a method to map complex systems, such as advanced driving assistance systems (ADAS) and the like, to fused and switched power feeds, grounding arrays, and network bus structures. Utilizing the master control module 206 and the zonal controllers 202 allows for rapid integration of the vehicle body 102 and associated components to the electrified body 102 via established physical wiring interconnections and flashable body electronics software. This may lead to up to 50 percent added functionality without complicated hardware changes. Establishing a flexible zonal architecture with the power rail assembly 300 may allow for shorter timelines between design and production as it provides an infrastructure to rapidly integrate a vehicle body 102 to a validated electrified chassis 104. Adding and deleting components comes with lower risk and lead times and reduces the amount of development and research needed for new production lines. Further, the platform may be utilized over a longer production life even with integration of newer technologies.

In other words, in lieu of traditional wire cables and harnesses, the hard-tooled tray 302 of the power rail assembly 300 may house, insulate, and protect the rigid bus bar of the power connector 304 and stacked flat cables of the data connector 306, and the power rail assembly 300 may be installed as one large assembly that has precise dimensional attachment points. All or a majority of the power and data may be predefined within the power rail assembly 300 and supplemented as needed by localized wiring harnesses 204. The power and data communications for devices accommodated by the body portion 102 may be provided by connecting the power rail assembly 300 as the body 102 is mounted to the chassis 104. That is, electrification is provided to the body portion 102 when the two mating halves are brought together. For example, a dock and lock connector system may engage as the chassis 104 and body portion 102 are brought together.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims.

What is claimed is:

1. A power rail assembly for a vehicle, the power rail assembly comprising:
a tray configured for mounting the power rail assembly at a vehicle;
a power connector accommodated by the tray, the power connector configured to electrically connect between a power source of the vehicle and an electrically operable component of the vehicle with the power rail assembly mounted at the vehicle; and
a data connector accommodated by the tray, the data connector configured to communicatively connect between a master control module of the vehicle and a zonal control module of the vehicle with the power rail assembly mounted at the vehicle.

2. The power rail assembly of claim 1, wherein the tray mounts along a chassis of the vehicle.

3. The power rail assembly of claim 2, wherein the electrically operable component is disposed at a body of the vehicle mated to the chassis of the vehicle.

4. The power rail assembly of claim 1, wherein the tray extends along a centerline of the vehicle.

5. The power rail assembly of claim 1, wherein the tray extends along a respective side of the vehicle.

6. The power rail assembly of claim 1, wherein a fuse box is electrically connected between the power connector and the electrically operable component, the fuse box mounted to the tray.

7. The power rail assembly of claim 6, wherein the fuse box is electrically connected between the power source and the power connector.

8. The power rail assembly of claim 1, wherein the zonal control module is electrically connected between the power connector and the electrically operable component.

9. The power rail assembly of claim 1, wherein:
the power source comprises a battery of the vehicle; and
the battery is configured to at least one of electrically power accessories of the vehicle, electrically power a propulsion system of the vehicle, or electrically connect to the power connector via a DC-DC converter.

10. The power rail assembly of claim 1, wherein the power connector and the data connector are stacked vertically relative to one another along the tray.

11. A vehicle comprising:
a power source;
an electrically operable component;
a master control module;
a zonal control module; and
a power rail assembly, the power rail assembly comprising:
a tray mounting the power rail assembly at the vehicle;
a power connector accommodated by the tray, the power connector electrically connected between the power source and the electrically operable component; and
a data connector accommodated by the tray, the data connector communicatively connected between the master control module and the zonal control module.

12. The vehicle of claim 11, wherein the tray mounts along a chassis of the vehicle.

13. The vehicle of claim 12, wherein the electrically operable component is disposed at a body of the vehicle mated to the chassis of the vehicle.

14. The vehicle of claim 11, wherein the tray extends along a centerline of the vehicle.

15. The vehicle of claim 11, wherein the tray extends along a respective side of the vehicle.

16. The vehicle of claim 11, further comprising a fuse box electrically connected between the power connector and the electrically operable component, the fuse box mounted to the tray.

17. The vehicle of claim 16, wherein the fuse box is electrically connected between the power source and the power connector.

18. The vehicle of claim 11, wherein the zonal control module is electrically connected between the power connector and the electrically operable component.

19. The vehicle of claim 11, wherein:
the power source comprises a battery; and
the battery is configured to at least one of electrically power accessories of the vehicle, electrically power a propulsion system of the vehicle, or electrically connect to the power connector via a DC-DC converter.

20. The vehicle of claim 11, wherein the power connector and the data connector are stacked vertically relative to one another along the tray.
